(19) United States
(12) Patent Application Publication
(10) Pub. No.: US 2024/0246322 A1
(43) Pub. Date: Jul. 25, 2024

(54) BUILDING PANEL AND METHOD TO PRODUCE SUCH A BUILDING PANEL

(71) Applicant: Välinge Innovation AB, ViKen (SE)

(72) Inventor: Göran Ziegler, VIKEN (SE)

(73) Assignee: Välinge Innovation AB, Viken (SE)

(21) Appl. No.: 18/289,506

(22) PCT Filed: May 11, 2022
(86) PCT No.: PCT/SE2022/050464

§ 371 Date: Nov. 3, 2023

(30) Foreign Application Priority Data
May 12, 2021 (SE) 2150608-4

(51) Int. Cl. B32B 21/06; B27D 1/08; B32B 3/02; B32B 3/18; B32B 3/26; B32B 5/02; B32B 7/023; B32B 21/02; B32B 21/14; B32B 29/00; B32B 29/02; B32B 37/18; B32B 38/00; E04F 13/08; E04F 13/10; E04F 15/02; E04F 15/04

(52) U.S. Cl. CPC B32B 21/06; B27D 1/08; B32B 3/02; B32B 3/18; B32B 3/266; B32B 5/02; B32B 7/023; B32B 21/02; B32B 21/14; B32B 29/005; B32B 29/02; B32B 37/18; B32B 38/0004; E04F 13/0889; E04F 13/10; E04F 15/02033; E04F 15/041; B32B 2260/021; B32B 2260/046; B32B 2307/4026; B32B 2317/12; B32B 2317/16; B32B 2607/00

(57) ABSTRACT

A building panel, including a core, a sublayer arranged above the core, where the sublayer includes at least one paper sheet. The building panel further includes a wood veneer layer arranged above the sublayer. The wood veneer layer includes at least one open structure. The building panel has a bevel arranged at least partly along at least one side portion. A first section of the sublayer is at least partly exposed in said bevel, where a second section of the sublayer is at least partly exposed in said at least one open structure of the wood veneer layer, and where the colour of said first section differs from the colour of said second section.

### TECHNICAL FIELD

The present application relates to a building panel and a method to produce such a building panel.

### TECHNICAL BACKGROUND

Floor coverings having a wooden surface may be of several different types. For example, solid wood flooring is formed of a solid piece of wood in form of a panel. Engineered wood floorings are formed of a surface layer of wood attached to a core, where the core may be a lamella core or a wood-based panel, such as plywood, MDF or HDF. Yet another example is a wood veneer being glued to a core. Wood veneer is a thin wood layer, e.g. having a thickness of 0.2-1 mm. Compared to solid wood and engineered wood flooring, wood veneer floorings can be produced to a lower cost since only a thin wood layer is used without losing the feeling of a natural wooden floor covering.

WO2015002599 discloses a floor covering, having a first layer and a second layer, including wood fibres, which can have different properties. In an example, it is disclosed that a first layer may have pigments to create a uniform colour to be able to cover a surface of a carrier having an uneven colour. The first layer may then be a good base layer for printing with its uniform colour. The document however does not address the possibilities of controlling the layers further in order to create a desirable overall design of a building panel, such as a veneered element.

WO2019139522 discloses a method to produce a veneered element and such a veneered element including a first layer, a second layer and a veneer layer. Described therein, the layers below the veneer layer may have different properties, where one layer may be pigmented or dyed and the other layer may be free from pigments and/or dye, or where the layers differ in colour. In this way the design of the veneer layer can be controlled after pressing the layers together where the layers below at least partly permeate into the veneer layer and, if there are open structures in the veneer layer, such as cracks or knots or holes, penetrate into these open structures of the veneer layer. However, the document does not disclose the impact of the different types of layers on the overall design of the veneered element.

### SUMMARY

An object of the present inventive concept is to provide improvements over known art.

In a first aspect of the present inventive concept there is provided a building panel, comprising:
a core,
a sublayer arranged above the core, wherein the sublayer comprises at least one paper sheet,
a wood veneer layer arranged above the sublayer, wherein the wood veneer layer comprises at least one open structure, and
a bevel arranged at least partly along at least one side portion of the building panel,
wherein a first section of the sublayer is at least partly exposed in the bevel, wherein a second section of the sublayer is at least partly exposed in the at least one open structure of the wood veneer layer, and wherein the colour of the first section differs from the colour of the second section.

By having a sublayer with different sections of different colour a desirable design of the building panel can be achieved with a preferred appearance in both the bevel and the area around open structures of the wood veneer layer. It is advantageous to be able to adapt the features of the sublayer in order to produce the desirable design of the building panel having any type of wood of the wood veneer layer.

In an embodiment, the paper sheet of the sublayer comprises a first portion which is at least partly exposed in the bevel and a second portion which is at least partly exposed in the open structure of the wood veneer layer.

The colour of the first portion may differ from the colour of the second portion of the paper sheet.

In an embodiment the first portion is a rim portion of the paper sheet and wherein the second portion is a centre portion of the paper sheet.

In yet another embodiment the first portion extends along the short sides and/or the long sides of the building panel.

Further, the sublayer may comprise at least two separate paper sheets, wherein a first paper sheet, having a first colour, is at least partly exposed in the bevel, wherein a second paper sheet, having a second colour, is at least partly exposed in the at least one open structure of the wood veneer layer, and wherein the first colour is different from the second colour.

In an embodiment the first paper sheet is arranged side by side, e.g., substantially non-overlapping, of the second paper sheet.

In another embodiment the first paper sheet is arranged in at least one rim portion of the building panel and the second paper sheet is arranged in a centre portion of the building panel. This may be achieved by either having an overlapping arrangement, i.e. the second paper sheet is arranged on top of the first paper sheet, or having a substantially non-overlapping arrangement, i.e. that the first paper sheet has a centered opening in which the second paper sheet is arranged, where the second paper sheet preferably has the same shape as the opening in the first paper sheet.

In an alternative embodiment the second paper sheet is at least partly arranged on top of the first paper sheet.

The second paper sheet may be at least partly arranged on top of the first paper sheet in an area of the sublayer below the at least one open structure of the wood veneer layer.

Yet further, the sublayer may comprise a top layer applied as a powder, wherein the paper sheet, having a first colour, is at least partly exposed in the bevel, wherein the top layer, having a second colour is at least exposed in the at least one open structure of the wood veneer layer, and wherein the colour of the paper sheet is different from the colour of the top layer.

In an embodiment the top layer is at least partly arranged on top of the paper sheet.

In another embodiment the top layer is at least partly arranged on top of the paper sheet in an area of the sublayer below the at least one open structure of the wood veneer layer.

In yet another embodiment the top layer comprises fibres, such as wood-based fibres, polymer-based fibres, colouring, such as pigments, coloured fibres and/or dye, fillers and an adhesive, chosen from one or more of a thermoplastic resin, a thermosetting resin or a combination thereof.

A top layer may include 30-70 wt. % fibres, 30-70 wt. % resin, 0-10 wt. % pigment and 0-10% fillers. Fillers may be CaCO₃, BaSO₄ or similar.

The paper sheet/s may comprise colouring such as pigments, coloured fibres and/or dye.

In a second aspect of the present application there is provided a building panel, comprising:
a core,
a sublayer arranged above the core, wherein the sublayer comprises an adhesive,
a wood veneer layer arranged above the sublayer, wherein the wood veneer layer comprises at least one open structure, and
a bevel arranged at least partly along at least one side portion of the building panel,
wherein a first section of the sublayer is at least partly exposed in the bevel, wherein a second section of the sublayer is at least partly exposed in the at least one open structure of the wood veneer layer, and wherein the colour of the first section differs from the colour of the second section.

Like for the first aspect, it is advantageous having a sublayer with different sections of different colour in order to create a desirable design of the building panel with a preferred appearance in both the bevel and the area around open structures of the wood veneer layer. It is also advantageous to be able to adapt the features of the sublayer in order to produce the desirable design of the building panel having any type of wood of the wood veneer layer.

The building panel may further comprise a second adhesive, wherein the first adhesive, having a first colour, is at least partly exposed in the bevel, wherein the adhesive, having a second colour is at least exposed in the at least one open structure of the wood veneer layer, and wherein the colour of the first adhesive is different from the colour of the second adhesive.

The adhesive/s may comprise colouring, such as pigment, coloured fibres and/or dye, and at least one filler. Colouring at an amount of 0-10 wt. % and fillers at an amount of 0-10 wt. %. Fillers may be CaCO₃, BaSO₄ or similar.

Adhesives such as PVAc glue, amino resin glue, hot melt, reactive hot melt may be used.

The amount of adhesive preferably is 25-200 g/m², even more preferably about 100 g/m².

In a third aspect of the present inventive concept there is provided a method to produce a building panel, comprising
applying a sublayer on a core,
applying a wood veneer layer on the sublayer,
applying pressure to form a building panel 1, and
forming a bevel at least partly around the building panel,
wherein, the sublayer comprises at least one paper sheet, and
wherein a first section of the sublayer is at least partly exposed in the bevel, wherein a second section of the sublayer is at least partly exposed in the at least one open structure of the wood veneer layer, and wherein the colour of the first section differs from the colour of the second section.

In an embodiment the bevel is formed along the short sides and/or the long sides of the building panel.

Further, applying the sublayer may comprise applying the paper sheet such that a first portion of the paper sheet is at least partly exposed in the bevel of the finished building panel and such that a second portion of the paper sheet is at least partly exposed in the open structure of the surface layer, of the finished building panel, wherein the colour of the first portion differs from the colour of the second portion.

Yet further, applying the sublayer may comprise:
applying a first paper sheet on the core, wherein the first paper sheet has a first colour, such that it is at least partly exposed in the bevel of the finished building panel, and
applying a second paper sheet above or side by side of the first paper sheet,
wherein the second paper sheet has a second colour, such that it is at least partly exposed in the at least one open structure of the wood veneer layer,
wherein the colour of the first paper sheet is different from the colour of the second paper sheet.

In an embodiment the second paper sheet is at least partly applied on top of the first paper sheet.

In an alternative embodiment applying the sublayer may comprise:
applying the paper sheet on the core, wherein the paper sheet has a first colour, such that the paper sheet is at least partly exposed in the bevel of the finished building panel, and
applying a powder layer above the paper sheet, wherein the powder layer has a second colour, such that the powder layer is at least partly exposed in the at least one open structure of the wood veneer layer of the finished building panel,
wherein the colour of the paper sheet is different from the colour of the powder layer.

In a fourth aspect of the present inventive concept there is provided a method to produce a building panel, comprising
applying a sublayer on a core,
applying a wood veneer layer on the sublayer,
applying pressure to form a building panel 1, and
forming a bevel at least partly around the building panel,
wherein, the sublayer comprises at least one adhesive, and
wherein a first section of the sublayer is at least partly exposed in the bevel, wherein a second section of the sublayer is at least partly exposed in the at least one open structure of the wood veneer layer, and wherein the colour of the first section differs from the colour of the second section.

Further, applying the sublayer may comprise:
applying a first adhesive on the core, wherein the first adhesive has a first colour, such that the first adhesive is at least partly exposed in the bevel of the finished building panel, and
applying a second adhesive side by side of the first adhesive, wherein the second adhesive has a second colour, such that the second adhesive is at least partly exposed in the at least one open structure of the wood veneer layer of the finished building panel,
wherein the colour of the first adhesive is different from the colour of the second adhesive.

### BRIEF DESCRIPTION OF THE DRAWINGS

Embodiments of the present inventive concept will be described in the following: reference being made to the appended drawings which illustrate non-limiting embodiments reduced into practice.

FIG. 1a is a schematic perspective view of a building panel according to an embodiment of the present inventive concept,

FIG. 1b is a schematic side view of the building panel in FIG. 1a,

FIG. 2 is an exploded view of a building panel according to a first embodiment of the present inventive concept,

FIG. 3 is an exploded view of a panel unit before split into four building panels, according to a second embodiment of the present inventive concept,

FIG. 4 is an exploded view of a panel unit before split into two building panels, according to a third embodiment of the present inventive concept,

FIG. 5 is an exploded view of a building panel according to a fourth embodiment of the present inventive concept,

FIG. 6 is an exploded view of a building panel according to a fifth embodiment of the present inventive concept,

FIG. 7 is an exploded view of a building panel according to a sixth embodiment of the present inventive concept,

FIG. 8 is an exploded view of a building panel according to a seventh embodiment of the present inventive concept,

FIG. 9 is an exploded view of a panel unit before split into two building panels, according to an eighth embodiment of the present inventive concept,

FIG. 10 schematically illustrates a method to produce a building panel illustrated in FIGS. 2-4,

FIG. 11 schematically illustrates another method to produce a building panel illustrated in FIGS. 5 and 6,

FIG. 12 schematically illustrates a method to produce a building panel illustrated in FIGS. 7 and 8, and

FIG. 13 schematically illustrates a method to produce a building panel illustrated in FIG. 9.

### DETAILED DESCRIPTION OF EMBODIMENTS

Specific embodiments will now be described with reference to the accompanying drawings. This invention should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The articles “a,” “an,” and “the” are used herein to refer to one or more than one (i.e., to at least one) of the grammatical object of the article. By way of example, “an element” means one element or more than one element.

As used herein, the term “about” means±10% of the noted value. By way of example only, a composition comprising “about 30 wt. %” of a compound could include from 27 wt. % of the compound up to and including 33 wt. % of the compound. The word “comprising” is used in a manner consistent with its open-ended meaning, that is, to mean that a given product or process can optionally also have additional features or elements beyond those expressly described. It is understood that wherever embodiments are described with the language “comprising,” otherwise analogous embodiments described in terms of “consisting of” and/or “consisting essentially of” are also contemplated and within the scope of this disclosure.

The different aspects, alternatives and embodiments of the invention disclosed herein can be combined with one or more of the other aspects, alternatives and embodiments described herein. Two or more aspects can be combined.

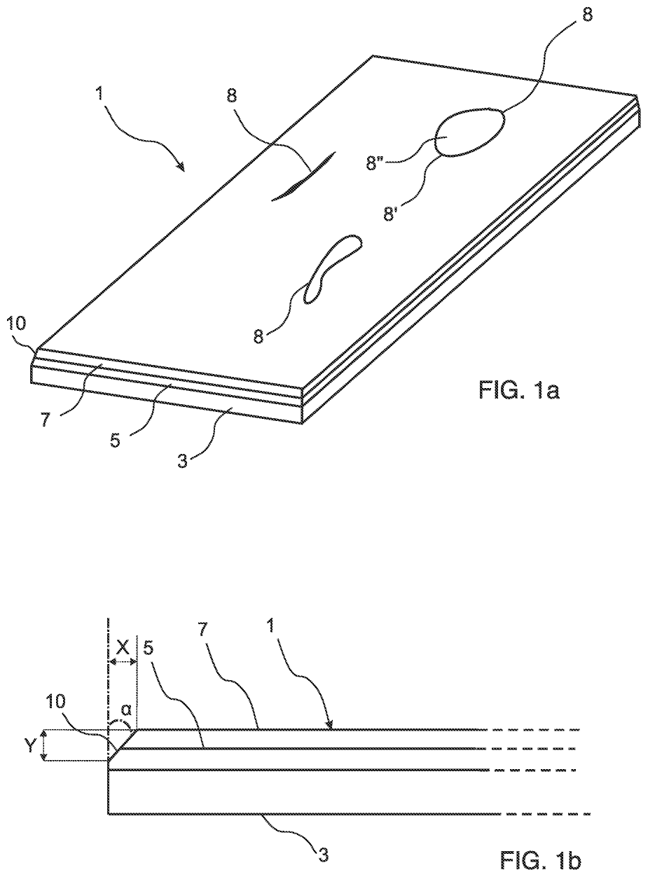

In FIGS. 1a and 1b a building panel 1 which may be a floor panel, a ceiling panel, a wall panel, a door panel, a worktop, skirting boards, a furniture component or a veneer element. The building panel 1 includes a core 3, a sublayer 5 and a surface layer 7 as illustrated. The core 3 may be a wood-based board, such as MDF or HDF board, a polymer-based board, such as a thermoplastic board, a particle board, a plywood, a lamella core, a veneer layer, a sheet and/or a non-woven.

On a first surface of the core 3 there is provided a sublayer 5. The sublayer 5 may be a homogenous layer or comprise two or more layers. The sublayer may comprise a thermosetting resin, a thermoplastic resin, or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof. Different types of possible sublayers are described in more detail below.

On top of the sublayer 5, opposite the core 3, there is provided a surface layer 7. The surface layer may be a homogenous layer or comprise two or more layers. In the shown example the surface layer is a wood veneer layer 7, preferably selected from oak, maple, birch, walnut, ash, and pine. The veneer layer 7 may have a thickness of less than 1 mm, such as 0.2 to 0.8 mm. The veneer layer may further be cut veneer, spliced veneer, sawn veneer, rotary cut veneer, and/or half-round cut veneer.

As illustrated in FIG. 1a, the veneer layer 7 has open structures 8 such as holes, knots and/or cracks. The open structures 8 may be naturally occurring in the veneer layer 7 or may be formed intentionally in the veneer layer 7, for example by brushing. The open structures 8 in the veneer layer 7 may extend through the thickness of the veneer layer 7 such that the open structure 8 is extending from one surface of the veneer layer 7 to an opposing surface. The open structures 8 in the veneer layer 7 may extend partially through the veneer layer 7 in the thickness direction.

Further, the building panel 1 further comprises a bevel 10. The bevel 10 may be provided along one side or several sides of the building panel 1. The bevel 10 may extend along a portion of the side or along the entire side of the building panel 1. It is preferred to at least have a bevel 10 extending along the short sides of the building panel 1.

The angle α of the bevel 10 is preferably between 20° and 45°, more preferably about 30°. The angle α is measured between a vertical axis and the surface of the bevel 10, as illustrated in FIG. 1b. The bevel 10 preferably has a width X of between 0.1 and 0.5 mm, more preferably around 0.3 mm. The width X of the bevel 10 is measured form the outer edge of the building panel 1 in towards the centre of the building panel 1, as illustrated in FIG. 1b. The bevel 10 preferably has a depth Y of between 0.1 and 0.5 mm. The depth Y of the bevel 10 is measured from the top surface of the surface layer 7 down towards the sublayer 5 and the core 3, as illustrated in FIG. 1b. The depth Y of the bevel 10 preferably extends through the surface layer 7 and through, or at least partly through, the sublayer 5. The depth Y of the bevel 10 preferably does not extend through or into the core 3.

Below, a number of different embodiments of the sublayer 5 are explained and illustrated in the drawings. A purpose with these embodiments is to be able to control and adapt the design of the building panel 1 by choosing a favourable sublayer 5 for a specific surface layer 7 and bevel 10. The design may mean colour, pattern, texture and/or gloss.

The surface layer 7 as explained above can be a wood veneer layer 7 of different sorts of wood, having different colours. Further, the wood veneer layer 7 may have at least one open structure 8, which of course have no colour, but which have a rim section 8′ with a colour often different from the colour of the rest of the wood veneer layer 7, e.g. the rim of the wood veneer layer 7. Therefore, when using a wood veneer layer 7 with open structure 8 as a surface layer, it may be preferred to have a sublayer 5, underneath the wood veneer layer 7, considering the different colours the wood veneer layer 8, as it will be visible through the open structure 8 and at least partly in the bevel 10. For example, the colour of a rim portion of the sublayer 5, may correspond to the colour of the rim of the wood veneer layer 7 in order to decrease unwanted visual effects, such as darker lines or shadows or brighter lines, or the colour of a centre portion of the sublayer 5, may correspond to the colour of the rim section 8′ of the open structure 8 of the wood veneer element 7 in order to make the empty space 8″ in the open structure 8 blend in with the wood veneer layer 7, or to create a unique design in the empty space 8″ of the open structure 8. Thus, the sublayer 5 preferably comprises colouring such as pigments, coloured fibres and/or dye

If, for example, a wood veneer layer made out of birch is used, the preferred colour of the rim portion of the sublayer may be in line with the light colour of the birch. An open structure of a wood veneer layer made out of birch would however have a rim section with a much darker colour than the rest of the rest of the wood veneer layer. Thus, the colour of the sublayer underneath the open structure would preferably be darker than the rim portion of the sublayer in order to blend in with the different colours of the birch.

The sublayer 5 may for all embodiments described below comprise one homogenous layer or comprise two or more layers. Further, the sublayer 5 may comprise an unimpregnated paper sheet or comprise a resin impregnated paper sheet. The resin may be a thermoplastic resin, a thermoset resin or a combination thereof. The weight of a preferred unimpregnated paper sheet is typically 20-50 g/m², usually about 25 g/m². The weight of a preferred resin impregnated paper sheet is typically 50-200 g/m² or 60-80 g/m².

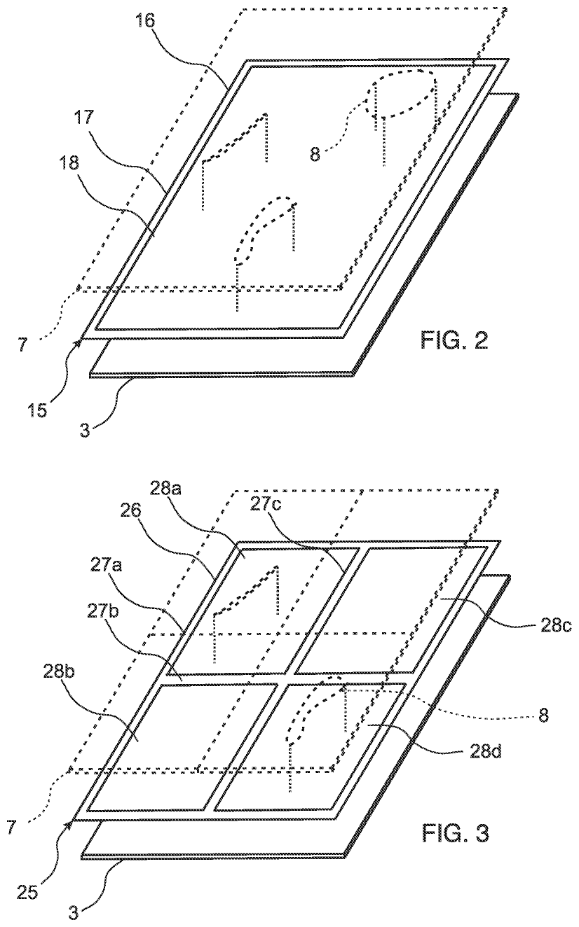

FIG. 2 is an exploded view of a building panel 1 for illustrating a possible sublayer 15 of the building panel 1. The sublayer 15 comprises a paper sheet 16. The paper sheet 16 has a rim portion 17 and a centre portion 18. The rim portion 17 extends all around the centre portion 18 and the paper sheet 16. The rim portion 17 will at least partly be exposed in the bevel 10 and therefore has a design which is preferred for the bevel 10. A design may mean colour, pattern, texture and/or gloss.

The rim portion 17 preferably extends from the edge of the paper sheet 16 into the paper sheet 16 of a width of between 0.1 and 3 mm. The smallest width the rim portion 17 extends into the sheet 16 is usually defined by the smallest bevel width. The largest width the rim portion 17 extends into the sheet 16 is usually defined by how close an open structure 8 may be the edge of the wood veneer layer 7. These widths are measured on a building panel 1 without a mechanical locking system (not shown).

If a building panel is provided with a mechanical locking system the width, or partially the width, of the locking system may be included in the preferred extension of the rim portion into the sheet.

The centre portion 18 will partly be exposed in an open structure 8 of the surface layer 7 and will therefore have a design which correspond the rim section 8′ of the open structure 8 if that is the preferred design of the building panel 1. A design may mean colour, pattern, texture and/or gloss.

In the illustrated embodiments the design is adapted with different colours. Thus, the paper sheet 16 is a coloured paper sheet comprising colouring such as pigments, coloured fibres and/or dye. The rim portion 17 and the centre portion 18 may have the same, similar or different colouring made from pigments, coloured fibres and/or dye.

The paper sheet 16 of the sublayer 15 may be a resin impregnated paper sheet. The sublayer may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

FIG. 3 is an exploded view of a panel unit 1′ which later is intended to be split, cut or sawn into four building panels 1, as illustrated by the dotted lines in the surface layer 7. The surface layer 7 is again illustrated as a wood veneer layer 7 with open structures 8. The panel unit 1′ in FIG. 3 has an alternative sublayer 25 and the sublayer 25 comprises a paper sheet 26. The paper sheet 26 has a first section comprising a rim portion 27a which extends all around the paper sheet 26 and two transverse portions 27b, 27c extending across the paper sheet 26. The first transverse portion 27b extends from the centre of one short side to the centre of the other short side across the paper sheet 26. The second transverse portion 27c extends from the centre of one long side to the centre of the other long side across the paper sheet 26. The two transverse portions 27b, 27c form a substantially equilateral cross on the paper sheet 26. The two transverse portion 27b, 27c have the same design, e.g. a colour as the rim portion 27a. This is preferred as the panel unit 1′ is later to be split into several building panels 1 where the transverse portions 27b, 27c becomes rim portions of the building panels 1. The split of the panel unit 1 is illustrated by the dotted lines in the surface layer 7. The rim portion 27a and the two transverse portions 27b, 27c preferably have a width of 0.1-3 mm. The smallest width the rim portion 27a extending into the sheet 26 is usually defined by the smallest bevel width. The largest width the rim portion 27a extending into the sheet 26 is usually defined by how close an open structure 8 may be the edge of the wood veneer layer 7. The smallest width of the transverse portion 27b, 27c may be defined as the smallest width of the rim portion 27a times two. Similar, the largest width of the transverse portions 27b, 27c may be defined as the largest width of the rim portion 27a times two.

The above defined widths are measured on a building panel 1 without a mechanical locking system (not shown).

If a building panel is provided with a mechanical locking system the width, or partially the width of the locking system may be included in the above defined width of the rim portion 27a, and transverse portions 27b, 27c.

In the shown embodiment of FIG. 3 there are four uniform centre portions 28a-28d. Each centre portion 28a-28d is bordered by sections from the rim portion 27a and the two transverse portions 27b, 27c. The centre portions 28a-28d are to cover most of the area of the surface layer 7 where open structures 8 are present. The centre portions 28a-28d have a design, e.g. a colour which is chosen to either blend in with the open structure 8 or to create another desirable design in the open structures 8 of the building panel 1. The rim portion 27a, the transverse portion 27b, 27c and each centre portion 28a-28d may each have the same, similar or different colouring made from pigments, coloured fibres and/or dye.

The paper sheet 26 of the sublayer 25 may be a resin impregnated paper sheet. The sublayer may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

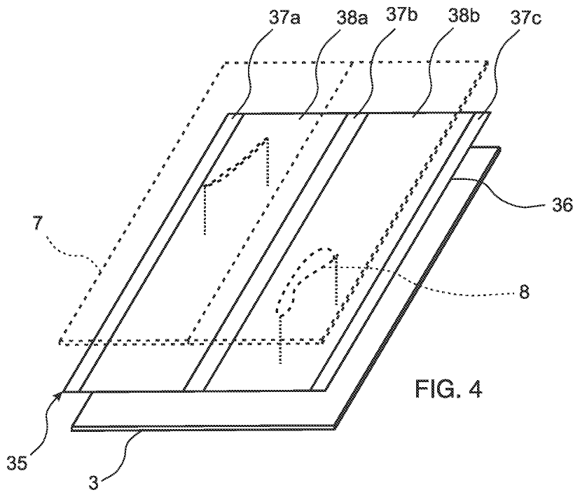

FIG. 4 is an exploded view of a panel unit 1′ which later is intended to be split, cut or sawn into two building panels 1. In this embodiment the sublayer 35 comprises a paper sheet 36 having five portions, two smaller rim portions 37a,37c, one smaller middle portion 37b, where a split of the panel unit 1′ is intended creating two rim portion, and two larger centre portions 38a, 38b. The rim portions 37a, 37c, the middle portion 37b and the centre portions 38a, 38b extend in a longitudinal direction of the above arranged surface layer 7, in the shown embodiment a wood veneer layer 7 with open structures 8. The first and the second rim portion 37a, 37c extends along the long sides of the panel unit 1′. The middle portion extends along an intended split in the panel unit 1′ for creating two building panels 1, illustrated with the dotted line in the centre of the surface layer 7. The rim portions 37a, 37c and the middle portion 37b have a design, e.g. a colour which is chosen to create the desirable design of the bevel of the building panel 1. The centre portions 38a, 38b have a design, e.g. a colour which is chosen to either blend in with the open structure 8 or to create another desirable design in an open structure 8 of the building panel 1.

The rim portions 37a, 37c preferably have the same design, e.g. colour as the middle portion 37b. This is preferred as the panel unit 1′ is later to be split into two building panels 1 where the middle portions 37b becomes rim portions of the building panels 1. The rim portions 37a, 37c and the middle portion 37b preferably have a width of 0.1-3 mm. The smallest width the rim portions 37a, 37c extending into the sheet 36 is usually defined by the smallest bevel width. The largest width the rim portions 37a, 37c extending into the sheet 36 is usually defined by how close an open structure 8 may be the edge of the wood veneer layer 7. The smallest width of the middle portion 37b may be defined as the smallest width of the rim portions 37a, 37c times two. Similar, the largest width of the middle portion 37b may be defined as the largest width of the rim portions 37a, 37c times two.

The above defined widths are measured on a building panel 1 without a mechanical locking system (not shown).

If a building panel is provided with a mechanical locking system the width, or partially the width of the locking system may be included in the above defined width of the rim portions 37a, 37c and the middle portion 37b.

The rim portions 37a-37c and centre portion 38a, 38b may each have the same, similar or different colouring made from pigments, coloured fibres and/or dye.

In an alternative embodiment the five portions 37a, 37b, 37c, 38a, 38b could be five separate paper sheet strips 37a, 37b, 37c, 38a, 38b arranged side by side to create the sublayer 35. The paper sheet strips 37a, 37b, 37c, 38a, 38b could in a manufacturing process be applied one by one or be pre-attached to each other in any suitable and desirable way. All features of the sublayer 35, as explained above for FIG. 4, applies also for this alternative embodiment.

The paper sheet 36 of the sublayer 35 may be a resin impregnated paper sheet. The sublayer may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

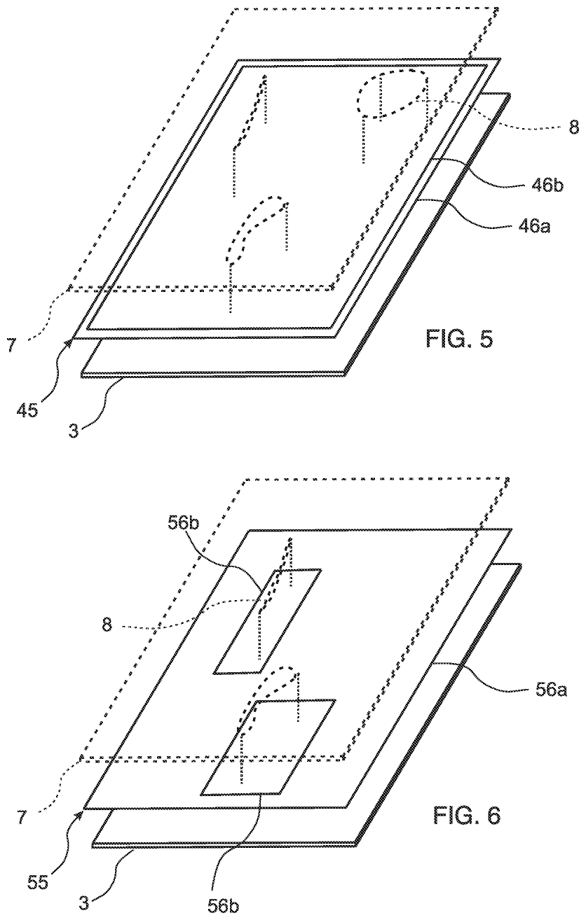

FIG. 5 illustrate yet another alternative embodiment of a sublayer 45. The building panel 1 includes a core 3, a sublayer 45 and a surface layer 7, where the surface layer 7 is illustrated as a wood veneer layer with open structures 8. The sublayer 45 comprises two paper sheets, where a first paper sheet 46a is arranged underneath a second paper sheet 46b. The first paper sheet 46a and the second paper sheet 46b are uniform but the first paper sheet 46a has a slightly larger area than the second paper sheet 46b. The second paper sheet 46b is centrally arranged on top of the first paper sheet 46a. The first paper sheet 46a is visible around the outer edges of the second paper sheet 46b such that the first paper sheet 46a is visible or at least exposed in a bevel extending around the building panel 1. Thus, the design and colour of the first paper sheet 46a is chosen to match the desirable design of the bevel of the building panel 1. The second paper sheet 46b is visible in the open structures 8 of the surface layer 7. Thus, the design and colour of the second paper sheet 46b is chosen to either blend in with the open structure 8 or to create another desirable design of open structure 8. The first paper sheet 46a and the second paper sheet 46b may have the same, similar or different colouring made from pigments, coloured fibres and/or dye.

In alternative embodiments to what has been described above the first paper sheet 46a may be shaped as an open frame, i.e. with a centered opening, where the second paper sheet 46b may be arranged within the frame. In an embodiment, the second paper sheet may be at least partly overlapping the first paper sheet 46a, e.g. around the centered opening. In an alternative embodiment, the second paper sheet may be shaped as the opening of the first paper sheet 46a, thus the second paper sheet 46b would substantially not overlap the first paper sheet 46a, e.g. around the centered opening. In a manufacturing process, the first and second paper sheet 46a, 46b, as described below, could be applied one by one or be pre-attached to each other in any suitable and desirable way.

The first and/or second paper sheet 46a, 46b of the sublayer 45 may be resin impregnated paper sheets. The sublayer may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

In a manufacturing process, the first and the second paper sheet 46a, 46b are either applied one by one or pre-attached to each other in any suitable way. Alternatively, the first paper sheet is a continuous sheet on which several second paper sheets are applied in a desirable pattern. The desirable pattern may be a homogenous pattern or a non-homogenous pattern (illustrated in FIG. 6). The first and the second paper sheet may be attached to each other by an added adhesive, e.g. a dry or moist adhesive made of a thermoplastic or thermoset material. Other suitable adhesives are hot-melt, reactive hot-melt, pressure-sensitive adhesive (PSA), glue, pvac-glue. Mechanical fastening means is an alternative way of attaching the paper sheets to each other. Such mechanical fastening means may for example be staples or needles.

FIG. 6 illustrate an alternative embodiment of having a sublayer 55 comprising at least two types of paper sheets 56a, 56b. The first paper sheet 56a is arranged underneath the second paper sheet 56b. In this embodiment however, compared to the embodiment illustrated in FIG. 5, second paper sheets 56b are arranged on the first paper sheet 56a only in areas where there is an open structure 8 present in the surface layer 7. In this way the consumption of the second paper sheet 56b is reduced. Thus the cost of the sublayer may be reduced or alternatively a more expensive paper sheet may be used in order to create unique designs of the building panel 1. The size and shape of the second paper sheet 56b may vary as the open structures 8 may vary in size and shape.

The first paper sheet 56a is visible around or at least partly exposed in a bevel extending around the building panel 1. Thus, the design and colour of the first paper sheet 56a is chosen to match the desirable design of the bevel of the building panel 1. The second paper sheets 56b are at least visible in the open structures 8 of the surface layer 7. Thus, the design and colour of the second paper sheets 56b is chosen to either blend in with the open structure 8 or to create another desirable design of open structure 8. The first paper sheet 56a and the second paper sheets 56b may have the same, similar or different colouring made from pigments, coloured fibres and/or dye.

The first and/or second paper sheet 56a, 56b of the sublayer 55 may be resin impregnated paper sheets. The sublayer may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

In the manufacturing process the first and the second paper sheet 56a, 56b are either applied one by one or pre-attached to each other in any suitable way. Alternatively, the first paper sheet is a continuous sheet on which several second paper sheets are applied in a desirable pattern. The desirable pattern may be a homogenous pattern or a non-homogenous pattern. The first and the second paper sheet may be attached to each other by an adhesive, e.g. a dry or moist adhesive made of a thermoplastic or thermoset material. Other suitable adhesives are hot-melt, reactive hot-melt, pressure-sensitive adhesive (PSA), glue, pvac-glue. Mechanical fastening means is an alternative way of attaching the paper sheets to each other. Such mechanical fastening means may for example be staples or needles.

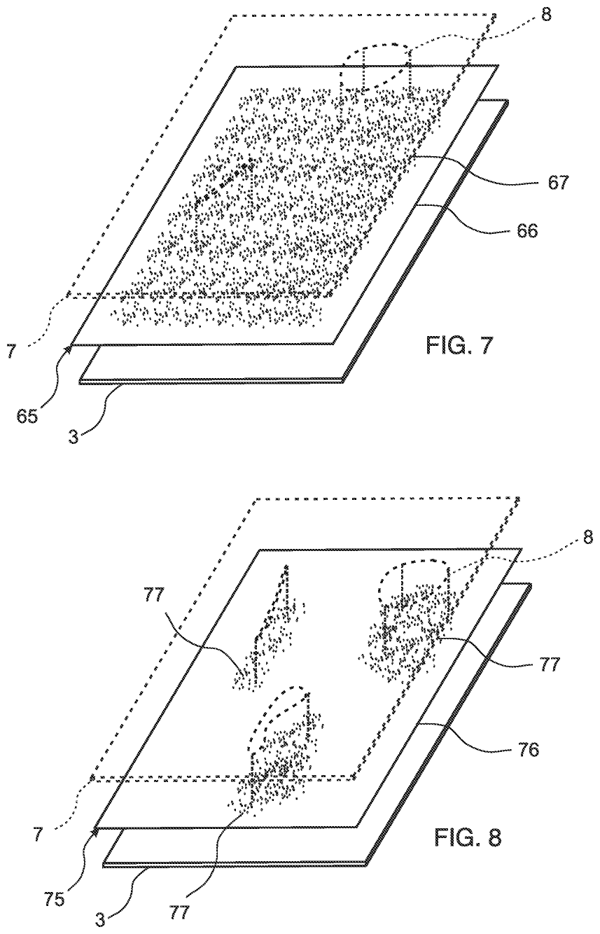

FIGS. 7 and 8 are alternatives having a sublayer 65, 75 comprising a paper sheet 66, 76 and one or several top layers 67, 77 applied as a powder. The powder of the top layer 67, 77 may be a dry powder. The powder may include 30-70 wt. % of fibres, 30-70 wt. % resin, 0-10 wt. % pigment and 0-10% fillers. Fillers may be CaCO₃, BaSO₄ or similar.

The building panel 1, illustrated in FIG. 7 includes a core 3, a sublayer 65 and a surface layer 7, where the surface layer 7 is illustrated as a wood veneer layer with open structures 8. The sublayer's 65 paper sheet 66 is arranged underneath the top layer 67. The top layer 67 is applied, spread out or scattered on the upper surface of the paper sheet 66 on an area covering most of the paper sheet 66. The paper sheet 66 is preferably only visible around the outer edges of the sublayer 65 such that the paper sheet 66 is visible or at least exposed in a bevel extending around the building panel 1. Thus, the design and colour of the paper sheet 66 is chosen to match the desirable design of the bevel of the building panel 1. The top layer 67 is applied in the center of the sublayer 65 and visible in the open structures 8 of the surface layer 7. Thus, the design and colour of the top layer 67 is chosen to either blend in with the open structure 8 or to create another desirable design of open structure 8. The paper sheet 66 and the top layer 67 may have the same, similar or different colouring made from pigments, coloured fibres and/or dye.

The composition of the powder of the top layer 67 may be a blend of fibres, e.g. wood fibres, an adhesive, e.g. made of a thermoplastic material, a thermoset material, or a combination thereof, and colourant, to create the desirable design in the open structures 8.

The powder can be in the form of a granulate comprising one or more of the components, described above, in the powder composition.

The paper sheet 66 of the sublayer 65 may be a resin impregnated paper sheet. The sublayer 65 may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

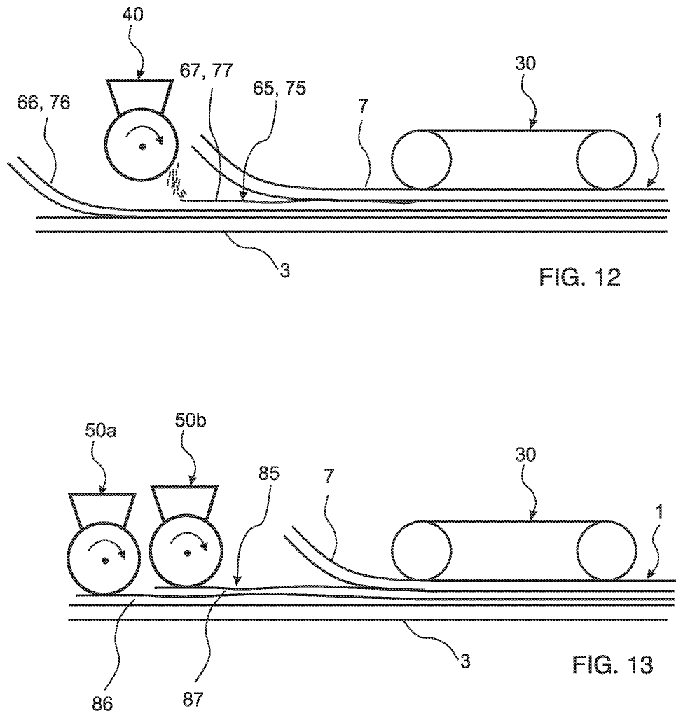

In the manufacturing process the powder of the top layer 67 is spread, scattered or in any other suitable way applied to the surface of the paper sheet 66 by an applicator 40 (illustrated in FIG. 12). The paper sheet 66 may be a continuous sheet, arranged on a roll. The paper sheet 66 may preferably have an adhesive, such as a liquid adhesive, or be moist in the area where the top layer 67 is to be applied, in order for the dry powder to stick to the paper sheet 66 more easily. Moistening the paper sheet 66 with adhesive may be made either by spraying, e.g. when the paper sheet passes under a spray box, or by passing under a steam box.

Adhesives such as PVAc glue, amino resin glue, hot melt, reactive hot melt may be used.

The amount of adhesive preferably is 25-200 g/m², even more preferably about 100 g/m².

After the powder of the top layer 67 has been applied excessive powder, not sticking to the adhesive or moist area may be removed. The adhesive or the moist area of the paper sheet 66 may have any desirable pattern. It may be a homogenous pattern or a non-homogenous pattern, where a substantially homogenous pattern is illustrated in FIG. 7 and a non-homogenous pattern is illustrated in FIG. 8.

As presented above, FIG. 8 illustrate an alternative embodiment of having a sublayer 75 comprising a paper sheet 76 and a top layer 77 applied as a powder. The top layer 77 is here arranged in sections on the first paper sheet 76, only in areas where there is an open structure 8 present in the surface layer 7. In this way the consumption of the powder is reduced. Thus, the cost of the sublayer may be reduced or alternatively a more expensive paper sheet or powder may be used in order to create unique designs of the building panel 1. The size and shape of the area where the powder of the top layer 77 is applied may vary as the open structures 8 may vary in size and shape.

The paper sheet 76 is visible around or at least partly exposed in a bevel extending around the building panel 1. Thus, the design and colour of the paper sheet 76 is chosen to match the desirable design of the bevel of the building panel 1. The top layer 77 is at least visible in the open structures 8 of the surface layer 7. Thus, the design and colour of the top layer 77 is chosen to either blend in with the open structure 8 or to create another desirable design of open structure 8. The paper sheet 76 and the top layers 77 may have the same, similar or different colouring made from pigments, coloured fibres and/or dye.

The paper sheet 76 of the sublayer 75 may be a resin impregnated paper sheet. The sublayer 75 may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

In the manufacturing process the powder of the top layer 77 is spread, scattered or in any other suitable way applied to the surface of the paper sheet 76, in the desirable areas of the paper sheet 76, by an applicator 40 (illustrated in FIG. 11). The paper sheet 76 may be a continuous sheet, arranged on a roll. The paper sheet 76 may preferably have an adhesive or be moist in the areas where the powder layer 77 is to be applied, in order for the dry powder to stick to the paper sheet 76 more easily. Alternatively, the powder of the top layer 77 may be applied evenly over the paper sheet 76. After the powder is evenly applied moisture may be applied, e.g. sprayed, onto desirable areas of the paper sheet 76 and the top layer 77. The moisture may be applied to desirable areas where the powder should be attached to the paper layer 76 in order to create a desirable pattern of the top layer 77.

The moisture may be applied either before or after applying the powder to the paper sheet 76.

After the powder of the top layer 77 and the moisture has been applied to the paper sheet 76, excessive powder, not sticking to the adhesive or moist area of the paper sheet 76, may be removed. The adhesive or the moist area of the paper sheet 76 may have any desirable pattern.

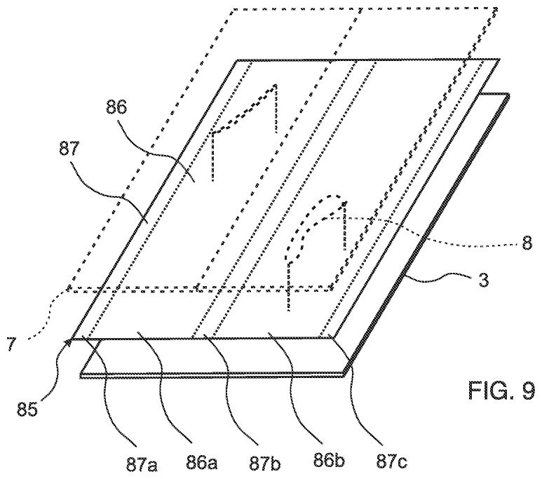

FIG. 9 is an exploded view of a panel unit 1′ which later is split, cut or sawn into two building panels 1. In this embodiment the sublayer 85 comprises two adhesives 86, 87 forming five portions, three thinner rim portions 87a-87c and two wider centre portions 86a, 86b.

The adhesive 86 forming the centre portions 86a, 86b may be applied over the entire surface of the core 3. The second adhesive 87 may then be applied on top of the first adhesive 86 when forming the rim portions 87a-87c.

Alternatively, the second adhesive 87, forming the rim portions 87a-87c may be applied over the entire surface of the core 3. The first adhesive 86 may then be applied on top of the first adhesive 87 when forming the centre portions 86a, 86b.

In yet another alternative embodiment, the two adhesives 86, 87 may be applied side by side in any desirable pattern.

The rim portions 87a-87c and the centre portions 86a, 86b extend in a longitudinal direction of the above arranged surface layer 7. The surface layer 7 is in the shown embodiment a wood veneer layer 7 with open structures 8. The first and the third rim portions 87a, 87c extend along the longer rims of the panel unit 1′. The second rim portion 87b extends along an intended split for creating two building panels 1, illustrated with the dotted line in the centre of the surface layer 7.

The adhesives 86, 87 comprise colouring made from, e.g., pigments, coloured fibres, and/or dye. The adhesive 87 in the rim portions 87a-87c may have one colouring and the adhesive 86 in the centre portions 86a, 86b may have another colouring. The rim portions 87a-87c have a design, e.g. a colour which is chosen to create the desirable design of the bevel of the building panel 1. The centre portions 86a, 86b have a design, e.g. a colour which is chosen to either blend in with the open structure 8 or to create another desirable design in the open structures 8 of the building panel 1. The rim portions 87a-87c and centre portions 86a, 86b may each have the same, similar or different colouring made from pigments, coloured fibres and/or dye.

The adhesives 86, 87 are preferably sprayed or rolled on the core 3 by the same or separate applicators 41a, 41b, during the manufacturing process (see FIG. 13), as explained below. The adhesives 86, 87 may comprise a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof. The adhesive 87 applied in the rim portion 87a-87c may have a different composition than the adhesive 86 applied in the centre portions 86a, 86b.

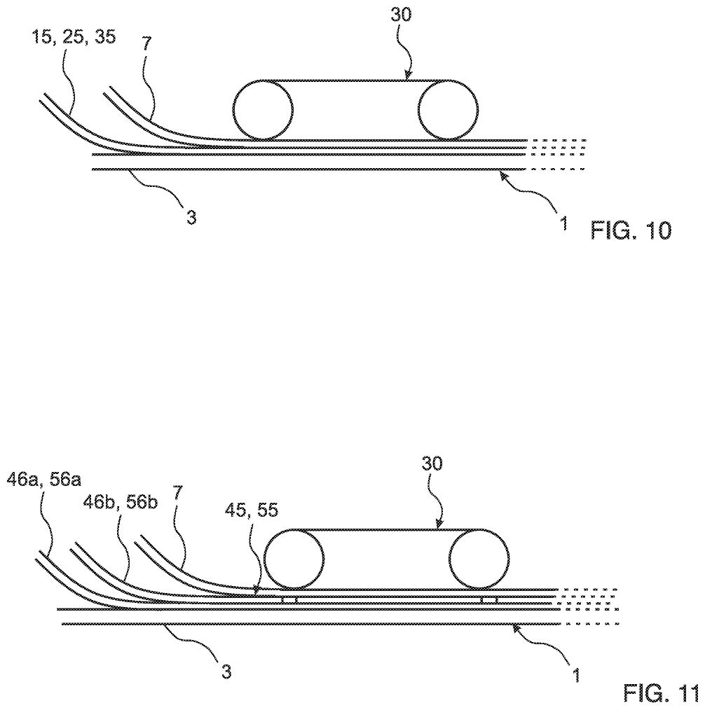

FIG. 10 illustrates a method to manufacture a building panel 1, wherein the process comprises:
providing a core 3,
applying a sublayer 15, 25, 35 on the core 3,
applying a surface layer 7 on the sublayer 15, 25, 35, and
applying pressure and preferably heat to form a building panel 1.

The core 3 is pre-made and may be a wood-based board, such as MDF or HDF board, a polymer-based board, such as a thermoplastic board, a particle board, a plywood, a lamella core, a veneer layer, a sheet and/or a non-woven.

The sublayer 15, 25, 35 comprises a paper sheet 16, 26, 36. The paper sheet 16, 26, 36 may be a resin impregnated paper sheet. The resin may be chosen from a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

The surface layer 7 comprises a wood veneer layer 7, preferably selected from oak, maple, birch, walnut, ash, and pine. The wood veneer layer 7 may have a thickness of less than 1 mm, such as 0.2 to 0.8 mm. The wood veneer layer 7 may further be cut veneer, spliced veneer, sawn veneer, rotary cut veneer, and/or half-round cut veneer. The wood veneer layer 7 may include at least one open structure 8, such as a hole, knot and/or crack. The open structure 8 may be naturally occurring in the veneer layer 7 or may be formed intentionally in the veneer layer 7, for example by brushing. The open structure 8 in the veneer layer 7 may extend through the thickness of the veneer layer 7 such that the open structure 8 is extending from one surface of the veneer layer 7 to an opposing surface. The open structure 8 in the veneer layer 7 may extend partially through the veneer layer 7 in the thickness direction.

Pressure may be applied in a continuous press 30, as shown in FIG. 10. As an alternative, a stationary press (not shown) may be used. The pressure applied may be in the range of 20-60 bar. The pressure time may be 10-60 s. The temperature applied may be in the range of 120-250° C., more preferably in the range of 160-220° C. and even more preferably about 200° C. During pressing, the surface layer 7 adheres to the core 3 by at least the resin in the sublayer 15, 25, 35.

Optionally, the method further comprises, after pressing, an operation of cutting or splitting the formed panel unit 1′ (along the dotted lines in FIGS. 3 and 4) into building panels 1 of the desirable size and shape.

The method yet further comprises forming a bevel 10. The bevel 10 may be formed by any suitable process, such as cutting, sawing or milling. The bevel 10 may be provided along one side or several sides of the building panel 1. The bevel 10 may extend along a portion of the side or along the entire side of the building panel 1. It is preferred to at least have a bevel 10 extending along the short sides of the building panel 1.

The angle α of the bevel 10 is preferably between 20° and 45°, more preferably about 30°. The angle α is measured between a vertical axis and the surface of the bevel 10, as illustrated in FIG. 1b. The bevel 10 preferably has a width X of between 0.1 and 0.5 mm, more preferably around 0.3 mm. The width X of the bevel 10 is measured form the outer edge of the building panel 1 in towards the centre of the building panel 1, as illustrated in FIG. 1b. The bevel 10 preferably has a depth Y of between 0.1 and 0.5 mm. The depth Y of the bevel 10 is measured from the top surface of the surface layer 7 down towards the sublayer 15, 25, 35 and the core 3, as illustrated in FIG. 1b. The depth Y of the bevel 10 preferably extends through the surface layer 7 and through or at least partly through the sublayer 15, 25, 35. The depth Y of the bevel 10 preferably does not extend through or into the core 3.

The paper sheet 16, 26, 36 is, in the manufacturing process, arranged such that its rim portions 17, 27a-c, 37a-c are at least partly exposed in the bevel 10 of the finished building panel 1, and its centre portions 18, 28a-d, 38a-b are at least partly exposed in the open structures 8 of the surface layer 7, of the finished building panel 1

FIG. 11 illustrates another method to manufacture a building panel 1, wherein the process comprises:
providing a core 3,
applying a sublayer 45, 55 on the core 3, wherein the sublayer 45, 55 includes a first paper sheet 46a, 56a and a second paper sheet 46b, 56b, wherein the second paper sheet 46b, 56b is arranged above the first paper sheet 46a, 56a,
applying a surface layer 7 on the sublayer 45, 55, and
applying pressure and preferably heat to form a building panel 1.

The core 3 is pre-made and may be a wood-based board, such as MDF or HDF board, a polymer-based board, such as a thermoplastic board, a particle board, a plywood, a lamella core, a veneer layer, a sheet and/or a non-woven.

The first paper sheet 46a, 56a and/or the second paper sheet 46b, 56b of the sublayer 45, 55 may be resin impregnated paper sheets. The resin may be chosen from a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

The surface layer 7 comprises a wood veneer layer 7, preferably selected from oak, maple, birch, walnut, ash, and pine. The wood veneer layer 7 may have a thickness of less than 1 mm, such as 0.2 to 0.8 mm. The wood veneer layer 7 may further be cut veneer, spliced veneer, sawn veneer, rotary cut veneer, and/or half-round cut veneer. The wood veneer layer may include at least one open structure 8, such as a hole, knot and/or crack. The open structure 8 may be naturally occurring in the veneer layer 7 or may be formed intentionally in the veneer layer 7, for example by brushing. The open structure 8 in the veneer layer 7 may extend through the thickness of the veneer layer 7 such that the open structure 8 is extending from one surface of the veneer layer 7 to an opposing surface. The open structure 8 in the veneer layer 7 may extend partially through the veneer layer 7 in the thickness direction.

Pressure may be applied in a continuous press 30, as shown in FIG. 11. As an alternative, a stationary press (not shown) may be used. The pressure applied may be in the range of 20-60 bar. The pressure time may be 10-60 s. The temperature applied may be in the range of 120-250° C., more preferably in the range of 160-220° C. and even more preferably about 200° C. During pressing, the surface layer 7 adheres to the core 3 by at least the resin in the sublayer 45, 55.

Optionally, the method further comprises, after pressing, an operation of cutting or splitting the formed panel unit 1′ into building panels 1 of the desirable size and shape.

The method yet further comprises forming a bevel 10. The bevel 10 may be formed by any suitable process, such as cutting, sawing or milling. The bevel 10 may be provided along one side or several sides of the building panel 1. The bevel 10 may extend along a portion of the side or along the entire side of the building panel 1. It is preferred to at least have a bevel 10 extending along the short sides of the building panel 1.

The angle α of the bevel 10 is preferably between 20° and 45°, more preferably about 30°. The angle α is measured between a vertical axis and the surface of the bevel 10, as illustrated in FIG. 1b. The bevel 10 preferably has a width X of between 0.1 and 0.5 mm, more preferably around 0.3 mm. The width X of the bevel 10 is measured form the outer edge of the building panel 1 in towards the centre of the building panel 1, as illustrated in FIG. 1b. The bevel 10 preferably has a depth Y of between 0.1 and 0.5 mm. The depth Y of the bevel 10 is measured from the top surface of the surface layer 7 down towards the sublayer 45, 55 and the core 3, as illustrated in FIG. 1b. The depth Y of the bevel 10 preferably extends through the surface layer 7 and through or at least partly through the sublayer 45, 55. The depth Y of the bevel 10 preferably does not extend through or into the core 3.

The first paper sheet 46a, 56a is, in the manufacturing process, arranged such that it is at least partly exposed in the bevel 10 of the finished building panel 1. The second paper sheet 46b, 56b is, in the manufacturing process, applied such that it is at least partly exposed in the open structures 8 of the surface layer 7, of the finished building panel 1.

FIG. 12 illustrates another method to manufacture a building panel 1, wherein the process comprises:
providing a core 3,
applying a sublayer 65, 75 on the core 3, wherein the sublayer 65, 75 includes a paper sheet 66, 76 and a powder layer 67, 77, wherein the powder layer 67, 77 is arranged above the paper sheet 66, 76,
applying a surface layer 7 on the sublayer 65, 75, and
applying pressure and preferably heat to form a building panel 1.

The core 3 is pre-made and may be a wood-based board, such as MDF or HDF board, a polymer-based board, such as a thermoplastic board, a particle board, a plywood, a lamella core, a veneer layer, a sheet and/or a non-woven.

The paper sheet 66, 76 may be a resin impregnated paper sheet and/or the powder layer 67, 77 may comprise a resin. The resin may be chosen from a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

The powder layer 67, 77 is spread, scattered or in any other suitable way applied to the surface of the paper sheet 66, 76 by an applicator 40. The powder may be a dry powder. The paper sheet 66, 76 may be a continuous sheet, arranged on a roll. The paper sheet 66, 76 may preferably have an adhesive or be moist in the area where the powder layer 67, 77 is to be applied, in order for the dry powder to stick to the paper sheet 66 76 more easily. After the powder layer 67, 77 has been applied excessive powder, not sticking to the adhesive or moist area may be removed. The adhesive or the moist area of the paper sheet 66, 76 may have any desirable pattern, as illustrated in FIGS. 7 and 8. It may be a homogenous pattern or a non-homogenous pattern, where a substantially homogenous pattern is illustrated in FIG. 7 and a non-homogenous pattern is illustrated in FIG. 8.

The surface layer 7 comprises a wood veneer layer 7, preferably selected from oak, maple, birch, walnut, ash, and pine. The wood veneer layer 7 may have a thickness of less than 1 mm, such as 0.2 to 0.8 mm. The wood veneer layer 7 may further be cut veneer, spliced veneer, sawn veneer, rotary cut veneer, and/or half-round cut veneer. The wood veneer layer may include at least one open structure 8, such as a hole, knot and/or crack.

The open structure 8 may be naturally occurring in the veneer layer 7 or may be formed intentionally in the veneer layer 7, for example by brushing. The open structure 8 in the veneer layer 7 may extend through the thickness of the veneer layer 7 such that the open structure 8 is extending from one surface of the veneer layer 7 to an opposing surface. The open structure 8 in the veneer layer 7 may extend partially through the veneer layer 7 in the thickness direction.

Pressure may be applied in a continuous press 30, as shown in FIG. 12. As an alternative, a stationary press (not shown) may be used. The pressure applied may be in the range of 20-60 bar. The pressure time may be 10-60 s. The temperature applied may be in the range of 120-250° C., more preferably in the range of 160-220° C. and even more preferably about 200° C. During pressing, the surface layer 7 adheres to the core 3 by at least the resin in the sublayer 65, 75.

Optionally, the method further comprises, after pressing, an operation of cutting or splitting the formed panel unit 1′ into building panels 1 of the desirable size and shape.

The method yet further comprises forming a bevel 10. The bevel 10 may be formed by any suitable process, such as cutting, sawing or milling. The bevel 10 may be provided along one side or several sides of the building panel 1. The bevel 10 may extend along a portion of the side or along the entire side of the building panel 1. It is preferred to at least have a bevel 10 extending along the short sides of the building panel 1.

The angle α of the bevel 10 is preferably between 20° and 45°, more preferably about 30°. The angle α is measured between a vertical axis and the surface of the bevel 10, as illustrated in FIG. 1b. The bevel 10 preferably has a width X of between 0.1 and 0.5 mm, more preferably around 0.3 mm. The width X of the bevel 10 is measured form the outer edge of the building panel 1 in towards the centre of the building panel 1, as illustrated in FIG. 1b. The bevel 10 preferably has a depth Y of between 0.1 and 0.5 mm. The depth Y of the bevel 10 is measured from the top surface of the surface layer 7 down towards the sublayer 65, 75 and the core 3, as illustrated in FIG. 1b. The depth Y of the bevel 10 preferably extends through the surface layer 7 and through or at least partly through the sublayer 65, 75. The depth Y of the bevel 10 preferably does not extend through or into the core 3.

The paper sheet 66, 76 is, in the manufacturing process, arranged such that it is at least partly exposed in the bevel 10 of the finished building panel 1. The powder layer 67, 77, is, in the manufacturing process, applied such that it is at least partly exposed in the open structures 8 of the surface layer 7, of the finished building panel 1.

FIG. 13 illustrates yet another method to manufacture a building panel 1, wherein the process comprises:
providing a core 3,
applying a sublayer 85 on the core 3, wherein the sublayer 85 includes a first adhesive 86 and a second adhesive 87, wherein the second adhesive 87 is arranged above, underneath or side by side the first adhesive 86,
applying a surface layer 7 on the sublayer 85 and
applying pressure and preferably heat to form a building panel 1.

The core 3 is pre-made and may be a wood-based board, such as MDF or HDF board, a polymer-based board, such as a thermoplastic board, a particle board, a plywood, a lamella core, a veneer layer, a sheet and/or a non-woven.

The first adhesive 86 may comprise a resin. The resin may be chosen from a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

The second adhesive 87 may comprise a resin. The resin may be chosen from a thermosetting resin, a thermoplastic resin or a combination thereof. A thermosetting resin may be an amino resin, for example melamine formaldehyde, urea formaldehyde, phenol formaldehyde, combinations thereof, or a co-polymer. A thermoplastic resin may be polyvinyl chloride (PVC), polyethylene (PE), polypropylene (PP), polyurethane (PU), polyvinyl alcohol (PVOH), polyvinyl butyral (PVB), polyvinyl acetate (PVAc), and/or thermoplastic elastomer (TPE), or a combination thereof.

The first and second adhesive 86, 87 may be applied, e.g. rolled, onto the core 3 by means of one or several applicators 50a, 50b.

The first and second adhesive 86, 87 may be applied in any desirable pattern. It may be a homogenous pattern or a non-homogenous pattern.

The surface layer 7 comprises a wood veneer layer 7, preferably selected from oak, maple, birch, walnut, ash, and pine. The wood veneer layer 7 may have a thickness of less than 1 mm, such as 0.2 to 0.8 mm. The wood veneer layer 7 may further be cut veneer, spliced veneer, sawn veneer, rotary cut veneer, and/or half-round cut veneer. The wood veneer layer may include at least one open structure 8, such as a hole, knot and/or crack. The open structure 8 may be naturally occurring in the veneer layer 7 or may be formed intentionally in the veneer layer 7, for example by brushing. The open structure 8 in the veneer layer 7 may extend through the thickness of the veneer layer 7 such that the open structure 8 is extending from one surface of the veneer layer 7 to an opposing surface. The open structure 8 in the veneer layer 7 may extend partially through the veneer layer 7 in the thickness direction.

Pressure and preferably heat may be applied by a continuous press 30, as shown in FIG. 13. As an alternative, a stationary press (not shown) may be used. The pressure applied may be in the range of 20-60 bar. The pressure time may be 10-60 s. The temperature applied may be in the range of 120-250° C., more preferably in the range of 160-220° C. and even more preferably about 200° ° C. During pressing, the surface layer 7 adheres to the core 3 by at least one resin in the sublayer 85.

Optionally, the method further comprises, after pressing, an operation of cutting or splitting the formed panel unit 1′ into building panels 1 of the desirable size and shape.

The method yet further comprises forming a bevel 10. The bevel 10 may be formed by any suitable process, such as cutting, sawing or milling. The bevel 10 may be provided along one side or several sides of the building panel 1. The bevel 10 may extend along a portion of the side or along the entire side of the building panel 1. It is preferred to at least have a bevel 10 extending along the short sides of the building panel 1.

The angle α of the bevel 10 is preferably between 20° and 45°, more preferably about 30°. The angle α is measured between a vertical axis and the surface of the bevel 10, as illustrated in FIG. 1b. The bevel 10 preferably has a width X of between 0.1 and 0.5 mm, more preferably around 0.3 mm. The width X of the bevel 10 is measured form the outer edge of the building panel 1 in towards the centre of the building panel 1, as illustrated in FIG. 1b. The bevel 10 preferably has a depth Y of between 0.1 and 0.5 mm. The depth Y of the bevel 10 is measured from the top surface of the surface layer 7 down towards the sublayer 65, 75 and the core 3, as illustrated in FIG. 1b. The depth Y of the bevel 10 preferably extends through the surface layer 7 and through or at least partly through the sublayer 85. The depth Y of the bevel 10 preferably does not extend through or into the core 3.

The first and second adhesive 86, 87 is, in the manufacturing process, applied such that the first adhesive 86 is at least partly exposed in the bevel 10 and the second adhesive 87 is at least partly exposed in the open structures 8 of the surface layer 7, of the finished building panel 1.

Finally, although the application has been described above with reference to specific embodiments, it is not intended to be limited to the specific form set forth herein. Rather, the application is limited only by the accompanying claims. Other embodiments than the specific above are equally possible within the scope of the appended claims.

1. A building panel, comprising:
a core,
a sublayer arranged above said core, wherein the sublayer comprises at least one paper sheet,
a wood veneer layer arranged above the sublayer, wherein the wood veneer layer comprises at least one open structure, and
a bevel arranged at least partly along at least one side portion of said building panel,
wherein a first section of the sublayer is at least partly exposed in said bevel, wherein a second section of the sublayer is at least partly exposed in said at least one open structure of the wood veneer layer, and wherein the colour of said first section differs from the colour of said second section.

2. The building panel according to claim 1, wherein the paper sheet of said sublayer comprises a first portion which is at least partly exposed in said bevel and a second portion which is at least partly exposed in said open structure of said wood veneer layer.

3. The building panel according to claim 2, wherein the colour of said first portion differs from the colour of said second portion of said paper sheet.

4. The building panel according to claim 2, wherein said first portion is a rim portion of said paper sheet and wherein said second portion is a centre portion of said paper sheet.

5. The building panel according claim 2, wherein the first portion extends along the short sides and/or the long sides of the building panel.

6. The building panel according to claim 1, wherein said sublayer comprises at least two separate paper sheets, wherein a first paper sheet, having a first colour, is at least partly exposed in said bevel, wherein a second paper sheet, having a second colour, is at least partly exposed in said at least one open structure of said wood veneer layer, and wherein the first colour is different from the second colour.

7. The building panel according to claim 6, wherein the first paper sheet is arranged side by side of the second paper sheet.

8. The building panel according to claim 6, wherein the first paper sheet is arranged in at least one rim portion of said building panel and said second paper sheet is arranged in a centre portion of said building panel.

9. The building panel according to claim 6, wherein the second paper sheet is at least partly arranged on top of the first paper sheet.

10. The building panel according to 6, wherein the second paper sheet is at least partly arranged on top of the first paper sheet in an area of the sublayer below the at least one open structure of the wood veneer layer.

11. The building panel according to claim 1, wherein said sublayer further comprises a top layer applied as a powder, wherein said paper sheet, having a first colour, is at least partly exposed in said bevel, wherein said top layer, having a second colour is at least exposed in said at least one open structure of said wood veneer layer, and wherein the colour of said paper sheet is different from the colour of said top layer.

12. The building panel according to claim 11, wherein the top layer is at least partly arranged on top of the paper sheet.

13. The building panel according to claim 11, wherein the top layer is at least partly arranged on top of the paper sheet in an area of the sublayer below the at least one open structure of the wood veneer layer.

14. The building panel according to claim 11, wherein said top layer comprises fibres, polymer-based fibres, colouring, coloured fibres and/or dye, and an adhesive, chosen from one or more of a thermoplastic resin, a thermosetting resin or a combination thereof.

15. The building panel according to claim 11, wherein said paper sheet/s comprise colouring.

16. A building panel, comprising:
a core,
a sublayer arranged above said core, wherein the sublayer comprises an adhesive,
a wood veneer layer arranged above the sublayer, wherein the wood veneer layer comprises at least one open structure, and
a bevel arranged at least partly along at least one side portion of said building panel,
wherein a first section of the sublayer is at least partly exposed in said bevel, wherein a second section of the sublayer is at least partly exposed in said at least one open structure of the wood veneer layer, and wherein the colour of said first section differs from the colour of said second section.

17. The building panel according to claim 16, further comprising a second adhesive, wherein said first adhesive, having a first colour, is at least partly exposed in said bevel, wherein said second adhesive, having a second colour, is at least exposed in said at least one open structure of said wood veneer layer, and wherein the colour of said first adhesive is different from the colour of said second adhesive.

18. The building panel according to claim 16, wherein the adhesive/s comprises colouring.

19. A method to produce a building panel, comprising
applying a sublayer on a core,
applying a wood veneer layer on the sublayer,
applying pressure to form a building panel, and
forming a bevel at least partly around said building panel,
wherein, the sublayer comprises at least one paper sheet; and
wherein a first section of the sublayer is at least partly exposed in said bevel, wherein a second section of the sublayer is at least partly exposed in said at least one open structure of the wood veneer layer, and wherein the colour of said first section differs from the colour of said second section.

20. The method according to claim 19, wherein said bevel is formed along the short sides and/or the long sides of the building panel.

21. The method according to claim 19, wherein applying the sublayer comprises applying the paper sheet such that a first portion of said paper sheet is at least partly exposed in said bevel of the finished building panel and such that a second portion of said paper sheet is at least partly exposed in said open structure of said wood veneer layer, of the finished building panel, wherein the colour of said first portion differs from the colour of said second portion.

22. The method according to claim 19, wherein applying the sublayer comprises:
applying a first paper sheet on the core, wherein the first paper sheet has a first colour, such that it is at least partly exposed in said bevel of the finished building panel, and
applying a second paper sheet above or side by side of the first paper sheet, wherein the second paper sheet has a second colour, such that it is at least partly exposed in said at least one open structure of said wood veneer layer,
wherein the colour of the first paper sheet is different from the colour of the second paper sheet.

23. The method according to claim 22, wherein the second paper sheet is at least partly applied on top of the first paper sheet.

24. The method according to claim 19, wherein applying the sublayer comprises:
applying the paper sheet on the core, wherein the paper sheet has a first colour, such that said paper sheet is at least partly exposed in said bevel of the finished building panel, and
applying a powder layer above the paper sheet, wherein the powder layer has a second colour, such that said powder layer is at least partly exposed in said at least one open structure of said wood veneer layer of the finished building panel,
wherein the colour of said paper sheet is different from the colour of said powder layer.

25. A method to produce a building panel, comprising
applying a sublayer on a core,
applying a wood veneer layer on the sublayer,
applying pressure to form a building panel, and
forming a bevel at least partly around said building panel,
wherein, the sublayer comprises at least one adhesive, and
wherein a first section of the sublayer is at least partly exposed in said bevel, wherein a second section of the sublayer is at least partly exposed in said at least one open structure of the wood veneer layer, and wherein the colour of said first section differs from the colour of said second section.

26. The method according to claim 25, wherein applying the sublayer comprises:
applying a first adhesive on the core, wherein the first adhesive has a first colour, such that said first adhesive is at least partly exposed in said bevel of the finished building panel, and
applying a second adhesive side by side of the first adhesive, wherein the second adhesive has a second colour, such that said second adhesive is at least partly exposed in said at least one open structure of said wood veneer layer of the finished building panel,
wherein the colour of said first adhesive is different from the colour of said second adhesive.
